(19) United States
(12) Patent Application Publication
(10) Pub. No.: US 2020/0211062 A1
(43) Pub. Date: Jul. 2, 2020

(54) SYSTEM AND METHOD UTILIZING SENSOR AND USER-SPECIFIC SENSITIVITY INFORMATION FOR UNDERTAKING TARGETED ACTIONS

(71) Applicant: Dmitri Kossakovski, La Crescenta, CA (US)

(72) Inventor: Dmitri Kossakovski, La Crescenta, CA (US)

(21) Appl. No.: 16/438,947

(22) Filed: Jun. 12, 2019

Related U.S. Application Data
(60) Provisional application No. 62/786,684, filed on Dec. 31, 2018.

(51) Int. Cl. G06Q 30/02; G06N 5/02

(52) U.S. Cl. CPC G06Q 30/0271; G06N 5/02

(57) ABSTRACT

A system and method automatically undertake context-specific and user-specific actions affecting comfort or wellness of users responsive to objective sensor information and subjective user sensitivity information. Such actions may include transmitting electronic communications, including communications affecting user comfort and/or wellness. A personalized, constantly learning approach generates real-time indices correlated to different subjective modalities and use these indices to take actions. Such actions may include providing advising and/or advertisements that are contextually related to a user's subjective state.

### STATEMENT OF RELATED APPLICATIONS

This application claims the benefit of U.S. Provisional Patent Application No. 62/786,684 filed on Dec. 31, 2018, wherein the disclosure of such application is hereby incorporated by reference herein.

### TECHNICAL FIELD

This disclosure relates to automated undertaking of context-specific and user-specific actions capable of affecting comfort or wellness of users responsive to objective sensor information and subjective user sensitivity information.

### BACKGROUND

Every person is different. When placed in the same objective environment, each person will have a personal, subjective experience in the environment. These subjective perceptions are influenced by a variety of factors, including, but not limited to facts such as: personal real-time physiology (metabolic state, etc.); personal biometrics (age, gender, body type, etc.); personal accumulated history (experiences, family background, upbringing, cultural background, etc.); personal near time history (sleep, food intake, physical activity, clothing choice, travel); calendar (hour of the day, day of the week, season); geographic localization; weather; environment (outdoors, indoors, vehicle); presence or absence of other people, animals or other objects, scents and tastes; and other factors. The deeply personal experience results in different people having different desires when placed in similar circumstances.

Conventional environment control systems and advertising services typically do not account for a personal, subjective, real-time state of individuals being targeted. Instead, they typically rely on a population average data and/or feedback from specific sensors. Such approaches have limited utility because they do not address the fact that the same objective information received from sensors may correspond to wildly different subjective states for different individuals—or even for the same individual at different times and/or in different contexts. Evidence for this limited utility is commonplace in the context of environmental comfort, as nearly everyone has had an experience of being in a car or a building in which only a small subset of occupants are in a state of thermal comfort, while the remaining occupants are either too warm or too cold. Likewise, similarly situated individuals may respond very differently to advertisements and other promotional communications, depending on subjective experience of users.

Efforts have been undertaken to generate quantifiable indices for different modalities of human perception. For example, in the field of thermal comfort, the work of F. De Oliveira et al (CSTB, Nantes, France) showed a possibility to generate a predictor of thermal comfort state of a person by using a combination of wearable and remote sensors. Similar studies have been performed by Jose Solaz et al (IBV, Valencia, Spain), Mihai Burzo (University of Michigan, Flint) and other research groups. Such prior art approaches are based on artificial intelligence (Al) and typically use a sampling of population on which the Al is trained. The subjects (i.e., users) are classified by their biometric information and are outfitted with sensors, both wearable and remote. The subjects are asked to complete comfort surveys at certain time intervals, and the results are combined with sensors data to produce an algorithm for comfort index generation. The resultant algorithm is then applied to new participants, outside of the training set. The system then typically evaluates new participants using the sensors as an input to the Al algorithm, which then generates a prediction of the participant's subjective state. Such systems do not typically learn from a specific user. Instead, such systems group a new subject into a specific sub-class of subjects on which the Al was trained, and the systems correlate the state of the new subject with the previously recorded states of subjects in this subclass. User-specific sensitivity or preference changes that may occur over time may not be taken into account.

Need exists for improved systems and methods that address limitations associated with conventional systems for undertaking actions capable of affecting comfort or wellness of users.

### SUMMARY

The present disclosure relates in various aspects to a system and method for automated undertaking of context-specific and user-specific actions capable of affecting comfort or wellness of users responsive to objective sensor information and subjective user sensitivity information. In certain implementations, such actions include transmission of electronic communications, including communications capable of affecting comfort or wellness of users. Examples of such communications include advertisements or promotional communications for at least one business, product, and/or service. The system and method enable a deeply personalized, constantly learning approach to generate real-time indices correlated to different subjective modalities (e.g. perception of thermal comfort, hunger, thirst, tiredness, etc.) and utilize these indices to offer a meaningful response in a form of advice or advertisement that is contextually related to the subjective state of the user.

In one aspect, the disclosure relates to an automated system for affecting comfort or wellness of a human user, the system comprising: a processor device configured to (i) receive at least one input signal from at least one sensor arranged to detect at least one condition indicative of a physiological and/or activity state of a human user, and (ii) to generate at least one output signal; and a communication generator configured to transmit, responsive to receipt of the at least one output signal, an electronic communication to be perceived by the human user or a third party, wherein the electronic communication comprises an advertisement or promotional communication for at least one business, product, and/or service. The processor device is configured to generate the at least one output signal utilizing a plurality of items including (i) the at least one input signal and (ii) user-specific sensitivity information that is indicative of individualized sensitivity of the human user to the at least one condition detected by the at least one sensor.

In certain embodiments, the at least one sensor includes a sensor that is wearable by the human user.

In certain embodiments, the at least one sensor is configured to measure at least one of the following: acceleration, motion, respiratory rate, respiratory rate variability, heart rate, heart rate variability, cardiogram, temperature, blood pressure, heat flux, muscle tone, skin conductivity, skin wettedness, muscle tone, acoustics, oxygen level, glucose level, hydration level, sodium ion secretion, imaging of exposed skin in visible or IR range, brain activity, or metabolic rate.

In certain embodiments, the at least one sensor is located remote from the human user and/or not wearable by the human user.

In certain embodiments, the at least one sensor is within an at least partially enclosed environment occupied by the human user.

In certain embodiments, the communication generator comprises a computer server operatively connected to at least one telecommunication network and/or social media network.

In certain embodiments, the communication generator is configured to transmit the electronic communication to a portable electronic communication device or personal computing device of the human user.

In certain embodiments, the electronic communication comprises at least one of an electronic mail communication, a short message service (SMS) communication, a social media communication, or a communication via a software application installed on a portable electronic communication device or personal computing device of the human user.

In certain embodiments, the plurality of items further includes historical physiological data of the human user.

In certain embodiments, the plurality of items further includes at least one of gender, age, height, or weight of the human user.

In certain embodiments, the plurality of items further includes at least one of cultural background or history of life in different climates of the human user.

In certain embodiments, the plurality of items further includes at least one of date, time, day of week, or season.

In certain embodiments, the plurality of items further includes geographic location of the human user.

In certain embodiments, the plurality of items further includes travel direction of the human user.

In certain embodiments, the plurality of items further includes at least one of local weather or local indoor climate experienced by the human user.

In certain embodiments, the plurality of items further includes personal calendar information for the human user.

In certain embodiments, the plurality of items further includes purchasing history of the human user.

In certain embodiments, the plurality of items further includes online browsing history and/or online search history of the human user.

In certain embodiments, the plurality of items further includes at least one of food or beverage consumption history of the human user.

In certain embodiments, the plurality of items further includes at least one of dietary restrictions or dietary goals of the human user.

In certain embodiments, the third party comprises a salesperson.

In certain embodiments, the third party comprises a relative, cohabitant, personal associate, or coach of the human user.

In certain embodiments, the third party comprises a medical professional.

In certain embodiments, the processor device is configured to use artificial intelligence to generate the at least one output signal.

In certain embodiments, the processor device is configured to generate the at least one output signal by further taking into account current or past action by the user, or inaction by the user, responsive to receipt by the user of at least one advertisement or promotional communication.

In another aspect, the disclosure relates to a method for affecting comfort or wellness of a human user, the method comprising multiple steps. One step includes detecting, with at least one sensor, at least one condition indicative of a physiological and/or activity state of a human user. Another step includes generating, with a processor device, at least one output signal utilizing a plurality of items including (i) at least one input signal produced by the at least one sensor and (ii) user-specific sensitivity information that is indicative of individualized sensitivity of the human user to the at least one condition detected by the at least one sensor. Another step includes, responsive to receipt of the at least one electronic output signal, transmitting an electronic communication by a communication generator to the human user or a third party, wherein the electronic communication comprises an advertisement or promotional communication for at least one business, product, and/or service.

In certain embodiments, the at least one sensor is worn by the human user.

In certain embodiments, the at least one sensor is configured to measure at least one of the following: acceleration, motion, respiratory rate, respiratory rate variability, heart rate, heart rate variability, cardiogram, temperature, blood pressure, heat flux, muscle tone, skin conductivity, skin wettedness, muscle tone, acoustics, oxygen level, glucose level, hydration level, sodium ion secretion, imaging of exposed skin in visible or IR range, brain activity, or metabolic rate.

In certain embodiments, the at least one sensor is located remote from the human user and/or not wearable by the human user.

In certain embodiments, the at least one sensor is within an at least partially enclosed environment occupied by the human user.

In certain embodiments, the plurality of items further includes historical physiological data of the human user.

In certain embodiments, the plurality of items further includes at least one of gender, age, height, or weight of the human user.

In certain embodiments, the plurality of items further includes at least one of cultural background or history of life in different climates of the human user.

In certain embodiments, the plurality of items further includes at least one of date, time, day of week, or season.

In certain embodiments, the plurality of items further includes geographic location of the human user.

In certain embodiments, the plurality of items further includes travel direction of the human user.

In certain embodiments, the plurality of items further includes at least one of local weather or local indoor climate experienced by the human user.

In certain embodiments, the plurality of items further includes personal calendar information for the human user.

In certain embodiments, the plurality of items further includes purchasing history of the human user.

In certain embodiments, the plurality of items further includes online browsing history and/or online search history of the human user.

In certain embodiments, the plurality of items further includes at least one of food or beverage consumption history of the human user.

In certain embodiments, the plurality of items further includes at least one of dietary restrictions or dietary goals of the human user.

In certain embodiments, the third party comprises a salesperson.

In certain embodiments, the third party comprises a relative, cohabitant, personal associate, or coach of the human user.

In certain embodiments, the third party comprises a medical professional.

In certain embodiments, the method further comprises prompting the human user to provide or update the user-specific sensitivity information.

In certain embodiments, the generating of at least one output signal with the processor device utilizes artificial intelligence.

In another aspect, any of the foregoing aspects, and/or various separate aspects and features as described herein, may be combined for additional advantage. Any of the various features and elements as disclosed herein may be combined with one or more other disclosed features and elements unless indicated to the contrary herein.

Other aspects, features and embodiments of the present disclosure will be more fully apparent from the ensuing disclosure and appended claims.

### BRIEF DESCRIPTION OF DRAWINGS

FIG. 1 is a schematic diagram illustrating interconnections between various components of an exemplary automated system for affecting comfort or wellness of a human user according to one embodiment of the present disclosure.

FIG. 2 is a schematic diagram of a generalized representation of a computer system that can be included in any component of the systems or methods disclosed herein.

### DETAILED DESCRIPTION

Aspects of the present disclosure provide a system and method for automated undertaking of context-specific and user-specific actions capable of affecting comfort or wellness of users responsive to objective sensor information and subjective user sensitivity information. In certain implementations, such actions include transmission of electronic communications, including communications capable of affecting comfort or wellness of users. A deeply personalized, constantly learning approach is provided for generating real-time indices correlated to different subjective modalities (e.g. perception of thermal comfort, hunger, thirst, tiredness, etc.) and utilizing these indices to take specified actions. Such actions may include providing advice and/or advertisements that are contextually related to the subjective state of the user.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

In certain embodiments, several classes of data may be synthesized to create a model (e.g., a real-time model) of a user's subjective state. Such classes may include:
Physiological data (real-time and historical).
Biometric data of the user (gender, age, height, weight etc.)
Historical data of the user (cultural background/bias, history of life in different climates)
User's calendar information (specific activities like being in an office or gym).
Common information extrinsic relative to the user (e.g., time of day, day of the week, season, weather, local indoor climate, geolocation).
Such classes of data are considered in more detail hereinafter.

### Physiological Data.

A human subject may have at least one associated sensor that measures one or more real-time physiological parameters. Such sensors may be wearable (e.g., a smartwatch, bracelet, earring, watch, jewelry, headband, eye glasses, googles, AR/VR hardware, clothing), implantable, or otherwise associated with the user (e.g., optionally embodied in a smartphone or other personal electronic device). Real-time physiological parameters may include, without being limited to: mechanical motion, respiratory rate, respiratory rate variability, heart rate, heart rate variability, cardiogram, temperature, blood pressure, heat flux, muscle tone, skin conductivity, skin wettedness, muscle tone, acoustics, oxygen level, glucose level, hydration level, sodium ion secretion, imaging of exposed skin in visible or IR range, brain activity, metabolic rate, etc. Data concerning the foregoing parameters may be buffered and/or stored in a memory associated with the sensors (e.g., in a smartwatch, smartphone, or other device), and may be at least periodically transmitted to a processor.

In certain embodiments, in addition to real-time physiological data, the system may have access to historical physiological data from the subject. Such historical data may be stored in a memory physically associated with or proximate to the processor, and/or may be retained in a data repository remote from the processor. A combination of real-time and historical information allow the system to predict real-time subjective state of a user.

### Biometric Data

Biometrics play an important role in classifying users in relation to modeling conditions likely to comfort or provide wellness of the user. For example, the physiological differences in men and women result in different way men and women perceive thermal comfort. As another example, people with different body types have different thermal comfort perceptions.

### Historical Data Concerning the User

The importance of cultural background and biases is very high, because different societies associate different comfort characteristics with different environments. For example, it is well known that Northern Europeans have different criteria for thermal comfort as compared to people born and raised in the USA. Typically, Europeans prefer to be warmer instead of colder. This is reversed for people from the USA. Part of such bias is due to climatic differences and resultant body adaptation, and another part is related to behavioral habits and upbringing.

### Calendar Information

Our habits, routines, and performance are functionally related to activities and other factors that can typically be derived from personal calendar information. For example, a morning person can be detected by noting their alarm set at 4:30 am followed by a workout at the gym scheduled for 5:15 am. Such person would predictively be hungry and/or thirsty, and probably still warmed up, around 6:30 am. Addition of these factors strengthens the predicting ability of an algorithm.

### Common Information Extrinsic to the User

Our bodies react to the environment and behave differently depending on factors such as time of day, day of the week, seasons, and weather conditions. For example, external humidity plays a strong role in our hydration levels, and consequently in our feeling of thirst.

### Use of Data

In certain embodiments, information from one or more sensors and other sources is parsed to a processor device (e.g., including one or more electrically operative processors configured to implement a machine-readable instruction set, such as an artificial intelligence (Al) algorithm). In particular, the processor device may be configured to (i) receive at least one input signal from at least one sensor arranged to detect at least one condition indicative of a physiological and/or activity state of a human user, and (ii) to generate at least one output signal. The processor device is further configured to generate the at least one output signal utilizing a plurality of items including (a) the at least one input signal and (b) user-specific sensitivity information that is indicative of individualized sensitivity of the human user to the at least one condition detected by the at least one sensor. Generation of the at least one output signal may be performed by the processor device implementing an Al algorithm that is personalized to predict a subjective state of the user based on the information parsed to the processor.

In certain embodiments, a working copy of the Al algorithm may be stored and operated locally on a processor device local to the user (e.g., in a computer, smartphone, or other personal electronic device associated with the user, optionally as a client or application on the processor device local to the user). In certain embodiments, a working copy of the Al algorithm may be stored and operated in at least one processor device (e.g., arranged in a computer server or other device) remote from the user, such as in one or more Web-connected and/or cloud computing devices. In certain embodiments, a first part of the Al algorithm may be stored and/or operated as a client or application on a processor device local to the user, and a second part of the Al algorithm may be stored and/or operated remotely (e.g., on a computer server or one or more Web-connected and/or cloud computing devices), with the first part and the second part being configured to cooperate with one another. In certain embodiments, modules or the entirety of the Al algorithm may be mirrored on a device local to the user and at least one device remote from the user.

The prediction can be real-time (e.g., “this is the subjective state of the user right now”) or the prediction can be for a future time period (e.g., “this is how the user will feel in one hour”). An output of the processing unit is used to generate an action in response to an assumed subjective state of the user.

In certain embodiments, an action triggered by the processing unit may include transmission by a communication generator of an electronic communication to be perceived by the user or a third party, responsive to receipt of the at least one output signal. In certain embodiments, the electronic communication comprises an advertisement or promotional communication for at least one business, product, and/or service. Such business, product, and/or service that is the subject of the advertisement or promotional communication may affect (e.g., enhance) comfort or wellness (including health) of the user. In certain embodiments, the advertisement or promotional communication is matched to a subjective state of the person. For example, if the person feels too hot (and the algorithm predicts it with a sufficient level of certainty), then the communication may contain an offer of a cold drink from a nearby vendor. In certain embodiments, the electronic communication comprises health advice and/or behavioral advice to be communicated to the user.

Such an advertisement may be delivered to a personal device of the user. An alternative could be to deliver an advertisement to a local display that the user can see. For example, the advertisement can be shown on a promotion screen while the user is in a public place such as a store, a coffeeshop, or a rail car.

Another alternative for the use of information is to communicate it to a salesperson to enable provision of a targeted personalized recommendation to the user based on the user's state. For example, if the user is in the coffeeshop, and the system detects the “too hot” subjective state of thermal comfort, then the barista can offer the customer a cold drink. In certain embodiments, information about the thermal state of the customer could be transmitted to the barista via a screen in the vicinity of the point of sale.

In certain embodiments, a salesperson may be in the vicinity of a human user. In other embodiments, a salesperson may be remote from the human user, and may communicate with the user by voice, SMS, email, and/or other communication means.

In certain embodiments, an action triggered by the processing unit may include changing a state of an HVAC system to adjust the thermal state of the environment to improve the subjective state (e.g., thermal comfort) of the user. For example, if the user feels too cold (and the algorithm predicts it with a sufficient level of certainty), the HVAC set point will be adjusted in the direction of higher temperature.

Yet another example of such action could be a recommendation sent to the user that would improve the user's well-being. For example, if the user feels tired (and the algorithm predicts it with a sufficient level of certainty), the recommendation could be for the user to take a break from the current activity.

There is a variety of ways that an Al algorithm can be trained to correlate the information from sensors and extrinsic sources with the subjective state of a user. The specific training approach is outside of the scope of current invention. Examples of such training systems and approaches can include supervised or unsupervised neural networks, multivariate regressions, reinforcement learning, or other methods.

In certain embodiments, a standard algorithm may be developed by training an Al system on a variety of users. Then, when a specific user is presented to the algorithm, the algorithm classifies the user into one of multiple predetermined sub-classes, and then generates a prediction that is consistent with the behavior of subjects of this sub-class.

An important distinction of the approach disclosed herein is that once the algorithm is paired with a specific user, the algorithm continues to learn the specific habits and preferences of this particular user, unless or until the algorithm reaches an acceptable prediction level.

For example, in the case of thermal comfort, an acceptable prediction level may be considered at 80%, meaning that the algorithm will predict with at least 80% certainty the state of the thermal comfort of the user. This means that an algorithm would predict an action of the user to adjust an HVAC setting up or down in at least 80% of the instances when the user performed such an adjustment based on the user's thermal comfort perception. Once the algorithm reaches this level of mastery, it can gradually take over such adjustment chores from the user, thereby increasing the fraction of time when user is in state of thermal comfort.

Similar certainty levels to those used for determining thermal comfort may be acceptable for predicting levels of hunger or thirst for a user.

Restated, according to certain embodiments, an Al algorithm may create a unique, deeply personalized prediction system that synthesizes information from an initial training set, as well as real-time physiological information from a user and a variety of auxiliary, extrinsic information. In order to determine what a user wants during a training stage, a conventional approach involves periodically asking a customer about the customer's preferences (e.g. “rate your thermal sensation and comfort from −5 to +5”). However, such approach requires significant overhead, and users need to be well-trained. Although such a methodology may be employed in certain embodiments as disclosed herein, in more preferred embodiments, an algorithm may be trained by detecting a user's actions that are specific to the modality for which the algorithm is being trained. For example, in the case of training for recognition of thermal comfort state of a person, detectable user actions could be adjusting HVAC parameters at home, opening the windows in a car, or donning and removing a jacket. In the case of training for thirst detection, a relevant action would be getting or ordering a drink, of either hot or cold varieties. In certain embodiments, a type of drink may be taken into account. For example, consumption of coffee, iced coffee, tea or another caffeinated beverage may be related to a user's caffeine demand as well as to a user's level of thirst.

In certain embodiments, an Al algorithm may receive as input information concerning a user's response to an advertisement or promotion, and then utilize such information for further learning and personalization of the algorithm for a specific user. In certain embodiments, an Al algorithm may receive as different inputs whether a user viewed (or did not view) an advertisement or promotion, obtained (or declined) additional information regarding the advertisement or promotion (e.g., by selecting or clicking through a link to additional information regarding same), and/or whether the user purchased (or declined to purchase) goods or services responsive to the advertisement or promotion. Thus, either positive actions (e.g., accepting information or a promotion) or negative actions (e.g., disregarding or disagreeing with an offer) may be taken into account for learning and/or personalization of an Al algorithm as disclosed herein. In certain embodiments, a processor device implementing such an Al algorithm may be configured to generate at least one output signal taking into account (or further taking into account) current or past action by the user, or inaction by the user, responsive to receipt by the user of at least one advertisement or promotional communication.

As a result of this deeply personalized training, the prediction system becomes unique to a specific user, creating a model of the subjective perceptions, needs, and desires of this specific user in digital space. This bears similarity to a personalized news feed on Facebook, in which no two users have the same feed. Such a news feed is constantly being adjusted based on the individual preferences of each user, the user's prior history, and a multitude of other input parameters. In the case of the present disclosure, predictions of an algorithm become a proxy for subjective states of users.

### Inferring Subjective State of Users

In certain embodiments, a system disclosed here may be used to infer a subjective state of a user. Such predictions are valuable, actionable, monetizable real-time data that can be used to improve well-being of the person in a multitude of ways, either in real-time or in an anticipatory fashion. Such improvement can be suggested to the subject as an advice. Such advice can be a behavioral suggestion, a medical suggestion, a referral, or another type of advice.

Another way to act on the data is to provide an advertisement that targets the user, either in real-time or at a future time based on a present subject state or an anticipated future subjective state of the subject.

For example, if the system detects that a subject is in a state of thermal discomfort due to being hot, then an advertisement of a cold beverage may be delivered to the subject's communication device. Such advertisement may contain a timed promotion that is projected to be valid during a period of time while the subject is in the same thermal discomfort state. Conversely, if a subject is in a state of thermal discomfort due to being cold, then an advertisement of a hot beverage may be delivered to the subject.

The examples with drinks are given for illustration purposes only. A variety of products or services can be marketed this way. For example, if a subject in a cold thermal state, an advertisement for a vacation in a warm locale may be served. Alternatively, in this case an advertisement may be for warm item of clothing, or a thermal comfort device such as a heater. If the subject is thirsty or hungry, then an advertisement for a coffeeshop or a restaurant may be communicated to the user.

In certain embodiments, system disclosed here may be used to infer subjective states of one or more items specific to the user: mechanical comfort of the user; thermal comfort of the user; olfactory comfort of the user; olfactory comfort of the user; state of tiredness of the user; state of awareness of the user; state of hunger of the user; or state of thirst of the user.

In certain embodiments, a user may have the ability to opt-in and opt-out of the system. Alternatively, a user may set a specific threshold of subjective state above which the specific actions are occurring. For example, considering the case of thermal comfort once again, the user may not want any action to occur if they are moderately uncomfortable. However, if the severity of discomfort rises, then the user may be willing for actions to occur, i.e., HVAC to start operating or ads being served. The user may be able to regulate such threshold levels by adjustments in one or more user-accessible software applications (e.g., “apps”) linked to the system.

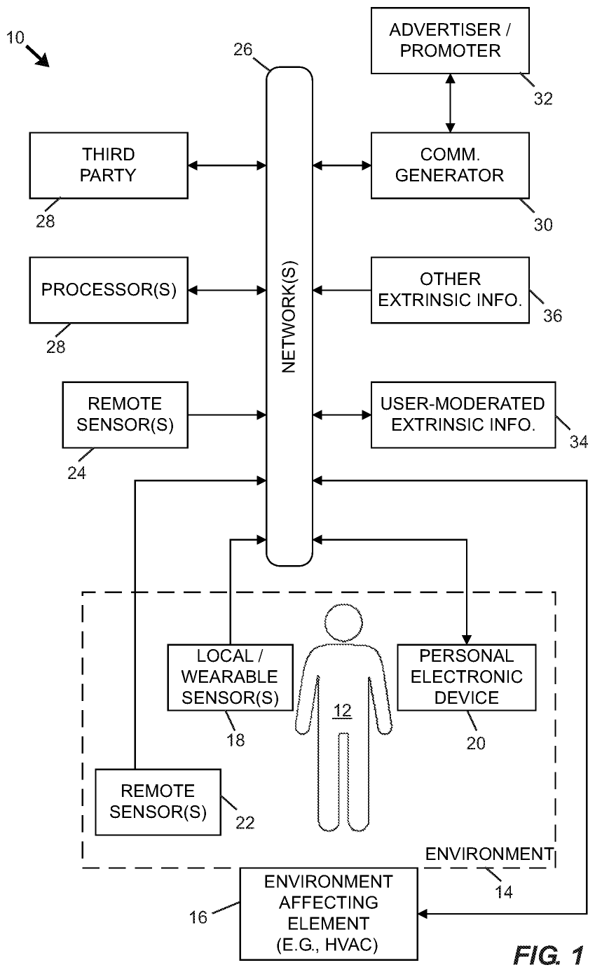

An exemplary automated system 10 for affecting comfort or wellness of a human user 12 according to one embodiment of the present disclosure is shown in FIG. 1. The user 12 may be located in an at least partially enclosed environment 14 (e.g., room, building, vehicle, etc.) having at least one environment affecting element 16 (e.g., HVAC unit, lighting controller, audio/visual system controller, home automation system etc.) configured to adjust or more user-perceptible qualities of the environment occupied by the user 12. One or more wearable or local sensors 18 (i.e., local to the user 12) are associated with the user 12, and the user 12 may further have an associated personal electronic device 20 (e.g., a smartphone). The at least partially enclosed environment 14 may further include one or more remote sensors 22 (i.e., remotely located relative to the user but still within the at least partially enclosed environment 14). One or more additional remote sensors 24 may be arranged outside the at least partially enclosed environment 14. In certain embodiments, the remote sensors 22, 24 may be configured to sense one or more items such as outdoor temperature, indoor temperature, humidity, lighting conditions, geolocation, calendar information, and weather information. One or more communication networks (e.g., including wired and/or wireless communication capability, optionally encompassing the Internet, intranets, social media networks, and/or wireless telephone or data networks) 26 are provided to facilitate communication between various elements of the automated system 10. One or more processors 28 (optionally embodied in one or more computing devices, servers, and/or personal electronic devices, including the personal electronic device 20 associated with the user 12) and a communication generator 30 are coupled with the network(s) 26, with the communication generator 30 (optionally embodying or including a computer server) being configured to propagate communications emanating from one or more advertisers or promoters 32. Such communications (which may comprises at least one of an electronic mail communication, a short message service (SMS) communication, a social media communication, or a communication via a software application) may be received by the personal electronic device 20 associated with the user 12. The one or more processors 28 may include memory associated therewith. Additionally, information stored in a user-moderated extrinsic information data repository 34 (e.g., including information received from, and/or editable by, the user 12) and an additional (other) extrinsic information data repository 36 is available to the one or more processors 28 via the network(s) 26. One or more third party devices 28 may also be coupled to network(s) 26. In certain embodiments, one or more third party devices 28 may be associated with third parties such as a salesperson in the vicinity of the human user; a relative, cohabitant, personal associate, or coach of the human user; and/or a medical professional (such as a doctor or clinician having responsibility for treating or advising the user 12). In certain embodiments, the one or more third party devices 28 may be a point of sale communication device (e.g., a point of sale display such as a video monitor or an online window).

In certain embodiments, the communication generator 30 and/or the processor(s) 28 may be integrated into the personal electronic device 20.

In certain embodiments, the wearable or local sensors 18 may be configured to measure at least one of the following: acceleration, motion, respiratory rate, respiratory rate variability, heart rate, heart rate variability, cardiogram, temperature, blood pressure, heat flux, muscle tone, skin conductivity, skin wettedness, muscle tone, acoustics, oxygen level, glucose level, hydration level, sodium ion secretion, imaging of exposed skin in visible or IR range, brain activity, personal activity, or metabolic rate. In certain embodiments, some or all of the wearable or local sensors 18 may be embodied in a smartwatch and/or integrated into the personal electronic device 20.

In certain embodiments, the wearable or local sensors 18 and/or the personal electronic device 20 may be used to determine geographic location and/or travel direction of the user 12.

In certain embodiments, the user-moderated extrinsic information data repository 34 may include historical physiological data of the human user (which may be derived from the local or wearable sensors 18, the personal electronic device 20, and/or electronic medical records of the user 12). In certain embodiments, the user-moderated extrinsic information data repository 34 may include at least one of gender, age, height, or weight of the human user, and/or at least one of cultural background or history of life in different climates of the user 12. In certain embodiments, the user-moderated extrinsic information data repository 34 may include information such as food or beverage consumption history of the user 12, or dietary restrictions or dietary goals of the user 12.

In certain embodiments, the additional (other) extrinsic information data repository 36 and/or the personal electronic device 20 may include as stored information a purchasing history of the user 12, an online browsing history of the user 12, and/or an online search history of the user 12, and such information may be available to the processor(s) 28.

In certain embodiments, operation of the environmental affecting element(s) 16 may be controlled responsive receipt of at least one output signal of the processor(s) 28 (generated utilizing at least one input signal from at least one sensor, and user-specific sensitivity information that is indicative of individualized sensitivity of the human user to the at least one condition detected by the at least one sensor) to affect comfort or wellness of the user 16.

### Exemplary System Components

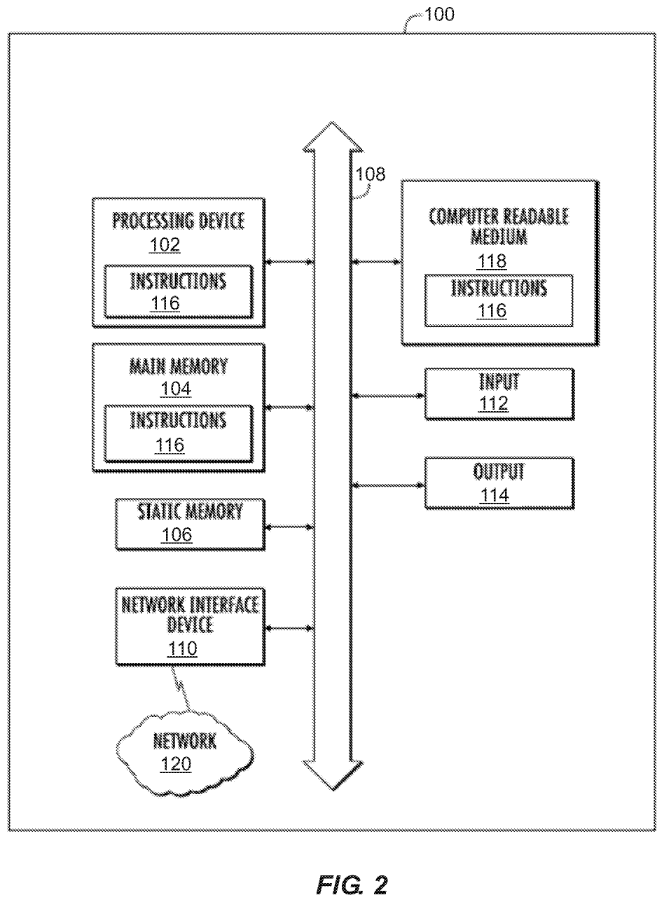

FIG. 2 is a schematic diagram of a generalized representation of a computer system 100 (optionally embodied in a processor and/or computing device) that can be included in any component of the systems or methods disclosed herein. In this regard, the computer system 100 is adapted to execute instructions from a computer-readable medium to perform these and/or any of the functions or processing described herein. In this regard, the computer system 100 in FIG. 2 may include a set of instructions that may be executed to program and configure programmable digital signal processing circuits for supporting scaling of supported communications services. The computer system 100 may be connected (e.g., networked) to other machines in a LAN, an intranet, an extranet, or the Internet. While only a single device is illustrated, the term “device” shall also be taken to include any collection of devices that individually or jointly execute a set (or multiple sets) of instructions to perform any one or more of the methodologies discussed herein. The computer system 100 may be a circuit or circuits included in an electronic board card, such as a printed circuit board (PCB), a server, a personal computer, a desktop computer, a laptop computer, a personal digital assistant (PDA), a computing pad, a smartphone, a mobile device, or any other device, and may represent, for example, a server or a user's computer.

In certain embodiments, a working copy of an Al algorithm may be stored in one or more devices of the computer system 100. In certain embodiments, a working copy of the Al algorithm may be stored and operated locally on a processing device 102 local to the user (e.g., a computer, smartphone, or other personal electronic device associated with the user, optionally as a client or application on the processing device 102). In certain embodiments, a working copy of the Al algorithm may be stored and operated in at least one processor device remote from the user (not shown) accessible via a network 120 (e.g., in a computer server or other device, optionally embodied in one or more Web-connected and/or cloud computing devices). In certain embodiments, a first part of the Al algorithm may be stored and/or operated as a client or application on a processing device 102 local to the user, and a second part of the Al algorithm may be stored and/or operated remotely (e.g., on a computer server or one or more Web-connected and/or cloud computing devices accessible via the network 120), with the first part and the second part being configured to cooperate with one another.

The computer system 100 shown in FIG. 2 includes a processing device or processor 102, a main memory 104 (e.g., read-only memory (ROM), flash memory, dynamic random access memory (DRAM), such as synchronous DRAM (SDRAM), etc.), and a static memory 106 (e.g., flash memory, static random access memory (SRAM), etc.), which may communicate with each other via a data bus 108. Alternatively, the processing device 102 may be connected to the main memory 104 and/or static memory 106 directly or via some other connectivity means. The processing device 102 may be a controller, and the main memory 104 or static memory 106 may be any type of memory.

The processing device 102 represents one or more general-purpose processing devices, such as a microprocessor, central processing unit, or the like. More particularly, the processing device 102 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 102 is configured to execute processing logic in instructions for performing the operations and steps discussed herein.

The computer system 100 may further include a network interface device 110. The computer system 100 also may or may not include an input 112, configured to receive input and selections to be communicated to the computer system 100 when executing instructions. The computer system 100 also may or may not include an output 114, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 100 may or may not include a data storage device that includes instructions 116 stored in a computer readable medium 118. The instructions 116 may also reside, completely or at least partially, within the main memory 104 and/or within the processing device 102 during execution thereof by the computer system 100, the main memory 104 and the processing device 102 also constituting computer readable medium. The instructions 116 may further be transmitted or received over a network 120 via the network interface device 110.

While the computer readable medium 118 is shown in an embodiment to be a single medium, the term “computer-readable medium” should be taken to include a single medium or multiple media (e.g., a centralized or distributed database, and/or associated caches and servers) that store the one or more sets of instructions. The term “computer readable medium” shall also be taken to include any medium that is capable of storing, encoding, or carrying a set of instructions for execution by the processing device and that cause the processing device to perform any one or more of the methodologies of the embodiments disclosed herein. The term “computer readable medium” shall accordingly be taken to include, but not be limited to, solid-state memories, optical media, and magnetic media.

The embodiments disclosed herein include various steps. The steps of the embodiments disclosed herein may be executed or performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer readable medium) having stored thereon instructions which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “analyzing,” “processing,” “computing,” “determining,” “displaying,” or the like, refer to the action and processes of a computer system, or a similar electronic computing device, that manipulates and transforms data and memories represented as physical (electronic) quantities within registers of the computer system into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems is disclosed in the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer readable medium and executed by a processor or other processing device, or combinations of both. The components of the system described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer readable medium known in the art. A storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the embodiments may be combined. Those of skill in the art will also understand that information and signals may be represented using any of a variety of technologies and techniques. For example, data, instructions, commands, information, signals, bits, symbols, and chips, which may be referenced throughout the above description, may be represented by voltages, currents, electromagnetic waves, magnetic fields, particles, optical fields, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It is contemplated that any or more features or characteristics of any one or more embodiments disclosed herein may be combined with those of other embodiments, unless specifically indicated to the contrary herein.

Systems and methods utilizing physiological data are disclosed by U.S. Pat. Nos. 7,285,090 and 6,595,929 of Bodymedia. However, the foregoing patents do not disclose creating a link between the physiological (objective) data and perceived state of comfort (subjective), or disclose the use of the derived information for real-time advertisement.

Those skilled in the art will recognize improvements and modifications to the embodiments of the present disclosure. All such improvements and modifications are considered within the scope of the concepts disclosed herein and the claims that follow.

1. An automated system for affecting comfort or wellness of a human user, the system comprising:
a processor device configured to (i) receive at least one input signal from at least one sensor arranged to detect at least one condition indicative of a physiological and/or activity state of a human user, and (ii) to generate at least one output signal; and
a communication generator configured to transmit, responsive to receipt of the at least one output signal, an electronic communication to be perceived by the human user or a third party, wherein the electronic communication comprises an advertisement or promotional communication for at least one business, product, and/or service;
wherein the processor device is configured to generate the at least one output signal utilizing a plurality of items including (a) the at least one input signal and (b) user-specific sensitivity information that is indicative of individualized sensitivity of the human user to the at least one condition detected by the at least one sensor.

2. The automated system of claim 1, wherein the at least one sensor includes a sensor that is wearable by the human user.

3. The automated system of claim 1, wherein the at least one sensor is configured to measure at least one of the following: acceleration, motion, respiratory rate, respiratory rate variability, heart rate, heart rate variability, cardiogram, temperature, blood pressure, heat flux, muscle tone, skin conductivity, skin wettedness, muscle tone, acoustics, oxygen level, glucose level, hydration level, sodium ion secretion, imaging of exposed skin in visible or IR range, brain activity, or metabolic rate.

4. The automated system of claim 1, wherein the at least one sensor includes a sensor located remote from the human user and/or not wearable by the human user.

5. The automated system of claim 1, wherein the at least one sensor is within an at least partially enclosed environment occupied by the human user.

6. The automated system of any one of claim 1, wherein the communication generator is configured to transmit the electronic communication to a portable electronic communication device or personal computing device of the human user.

7. The automated system of claim 1, wherein the plurality of items further includes at least one of cultural background or history of life in different climates of the human user.

8. The automated system of claim 1, wherein the plurality of items further includes at least one of geographic location of the human user or travel direction of the human user.

9. The automated system of claim 1, wherein the plurality of items further includes personal calendar information for the human user.

10. The automated system of claim 1, wherein the plurality of items further includes purchasing history of the human user.

11. The automated system of claim 1, wherein the plurality of items further includes at least one of: purchasing history of the human user, online browsing history of the human user, or online search history of the human user.

12. The automated system of claim 1, wherein the plurality of items further includes at least one of food or beverage consumption history of the human user.

13. The automated system of claim 1, wherein the plurality of items further includes at least one of dietary restrictions or dietary goals of the human user.

14. The automated system of claim 1, wherein the processor device is configured to use artificial intelligence to generate the at least one output signal.

15. The automated system of claim 1, wherein the processor device is configured to generate the at least one output signal by further taking into account current or past action by the user, or inaction by the user, responsive to receipt by the user of at least one advertisement or promotional communication.

16. A method for affecting comfort or wellness of a human user, the method comprising:
detecting, with at least one sensor, at least one condition indicative of a physiological and/or activity state of a human user;
generating, with a processor device, at least one output signal utilizing a plurality of items including (i) at least one input signal produced by the at least one sensor and (ii) user-specific sensitivity information that is indicative of individualized sensitivity of the human user to the at least one condition detected by the at least one sensor; and
responsive to receipt of the at least one electronic output signal, transmitting an electronic communication by a communication generator to the human user or a third party, wherein the electronic communication comprises an advertisement or promotional communication for at least one business, product, and/or service.

17. The method of claim 16, wherein the plurality of items further includes personal calendar information for the human user.

18. The method of claim 16, wherein the plurality of items further includes at least one of: purchasing history of the human user, online browsing history of the human user, or online search history of the human user.

19. The method of claim 16, wherein the third party comprises a salesperson.

20. The method of claim 16, further comprising prompting the human user to provide or update the user-specific sensitivity information.

21. The method of claim 16, wherein the generating of at least one output signal with the processor device utilizes artificial intelligence.
